(19) United States
(12) Patent Application Publication
(10) Pub. No.: US 2020/0293030 A1
(43) Pub. Date: Sep. 17, 2020

(54) DATA MANAGEMENT SYSTEM AND DATA MANAGEMENT METHOD

(71) Applicant: HITACHI, LTD., Tokyo (JP)

(72) Inventors: Jumpei Okoshi, Tokyo (JP); Tsunehiko Baba, Tokyo (JP); Toshihiko Kashiyama, Tokyo (JP); Nobukazu Kondo, Tokyo (JP)

(73) Assignee: HITACHI, LTD., Tokyo (JP)

(21) Appl. No.: 16/778,117

(22) Filed: Jan. 31, 2020

(30) Foreign Application Priority Data
Mar. 14, 2019 (JP) 2019-047428

(51) Int. Cl. G05B 19/418

(52) U.S. Cl. CPC G05B 19/41875; G05B 19/41865; G05B 19/4183

(57) ABSTRACT

The present invention realizes reuse of an analysis application having different contexts such as data units and data acquisition times of on-site data in short man-hour without requiring specialized knowledge on an analyzed object. A data management system providing IoT data to a service system includes a storage device storing an asset catalog containing information of a manufacture line and devices constructing a manufacture line, an application catalog containing calculation information of a KPI as required by the service system, and a data catalog containing information for accessing the IoT data. A control unit retrieves an asset to be analyzed from the catalog, and when the KPI does not exist in the asset catalog, retrieves the KPI calculation information from the application catalog, and calculates a KPI of the asset to be analyzed as the KPI as the requirement specification of the service system by using the retrieved calculation information.

### BACKGROUND

The present invention relates to a data management system and a data management method. For example, it relates to a technique suitable for data management for obtaining IoT data on site such as a manufacture line in a factory and providing services using the obtained IoT data.

Nowadays, in the social infrastructure field of railway, electric power, gas, and the like and the industrial field including a manufacturing plant, for realization of sophistication of maintenance, optimum transportation, and creation of new services by using data, application of Internet of Things (IoT) and big data analysis to services is expected. On the other hand, data formats from various devices and sensors used on site are various and even the same kind of data is often managed under different items or names in business systems. To analyze them together, preparation such as standardization of formats and data integration is necessary. Generally, it is said that such preparation work is a major part in an entire data analysis work and is an obstacle when data analysis is applied to business.

Consequently, it is demanded to streamline the analysis data preparation work which is said a major part in an entire data analysis work such as standardization of data formats and integration of data managed under different items or names.

In the manufacturing industry, for data analysis using an IoT platform (PF), a key performance indicator (KPI) group regarding manufacture is hierarchically managed as overall equipment effectiveness (OEE). For example, in the case of a manufacture line, it has to be properly presented to the managers of the manufacture line and layers of programmable logic controllers (PLCs) or the like constructing the manufacture line.

However, in reuse of an analysis application, long manhour is required for verification of applicability of the analysis application for reasons such that an application is not set as a part and IoT data to be applied cannot be retrieved. It is said that the manhour occupies about 50 percent of new development of an analysis application.

For example, Japanese Unexamined Patent Application Publication No. 2018-72958 (patent literature 1) discloses a data providing device of providing on-site data to a service device, which stores description information of on-site data including specifications of on-site data, description information of services including specifications of on-site data required by services and the on-site data, and a conversion rule for converting the specification of on-site data to the specification required by a service using the on-site data, which are preliminarily registered. In response to an on-site data transfer request from a service device, the data providing device converts all of on-site data used by a service provided by the service device to data in the specification required by the service with reference to the description information of the on-site data, the description information of the service, and the conversion rule and transmits the converted data to the service device.

### SUMMARY

In the technique described in the patent literature 1, it is necessary to explicitly designate description information of a service including on-site data required by a service and the specification of the on-site data and a conversion rule to convert the specification of on-site data to a specification required by a service using the on-site data. For the designation, a specification of on-site data, a specification required by a service, and a corresponding relation and a converting method of them have to be grasped and specialized knowledge is necessary.

An object of the present invention is to provide a data management system and a data management method realizing reuse of an analysis application having different contexts such as data units and data acquisition times of on-site data (for example, data of PLCs) in short man-hour without requiring specialized knowledge on an object to be analyzed, for example, a manufacture line or PLCs constructing a manufacture line.

To achieve the object, an embodiment of a data management system of the present invention is a data management system providing IoT data to a service system, which includes a storage device storing an asset catalog in which information of a manufacture line and devices constructing a manufacture line is written as an asset, an application catalog in which calculation information of a KPI as a requirement specification of the service system is written, and a data catalog in which information for accessing the IoT data is written. A control unit of the data management system retrieves an asset to be analyzed from the asset catalog and, when a KPI does not exist in the searched asset catalog, retrieves KPI calculation information from the application catalog, and calculates a KPI of the asset to be analyzed as the KPI as the requirement specification of the service system by using the retrieved KPI calculation information.

According to the present invention, reuse of an analysis application having different contexts such as data units and data acquisition times of on-site data (for example, data of PLCs) can be realized in short man-hour without requiring specialized knowledge on an object to be analyzed, for example, a manufacture line or PLCs constructing a manufacture line.

### BRIEF DESCRIPTION OF THE DRAWINGS

FIG. 1 is a diagram illustrating an example of a system configuration diagram of an embodiment.

FIG. 2 is a diagram illustrating an example of a hardware configuration diagram of the system of the embodiment.

FIG. 3 is a diagram illustrating an asset catalog of the embodiment.

FIG. 4 is a diagram illustrating an example of a data catalog of the embodiment.

FIG. 5 is a diagram illustrating an application catalog of the embodiment.

FIG. 6 is a diagram illustrating an example of a display screen of a data management system of the embodiment.

FIG. 7 is a diagram illustrating an example of the display screen of the data management system of the embodiment.

FIG. 8 is a diagram illustrating an example of the display screen of the data management system of the embodiment.

FIG. 9 is a diagram illustrating an example of a process flow of the data management system of the embodiment.

FIG. 10 is a diagram illustrating an example of the process flow of the data management system of the embodiment.

FIG. 11 is a diagram illustrating an example of the process flow of the data management system of the embodiment.

FIG. 12 is a diagram explaining a method of calculating a throughput of a PLC from a timestamp and a counter value of the asset catalog of the embodiment.

FIG. 13 is a diagram explaining a method of calculating a KPI of a line from KPIs of devices constructing the line.

### DETAILED DESCRIPTION

Embodiments will be described with reference to the drawings. However, the embodiment which will be described hereinafter does not limit the invention according to the scope of the claims of the invention, and all of elements and combinations of the elements described in the embodiment are not always necessary for the solving means of the invention.

In the following description, information will be described by expression of “AAA table”. However, information may be expressed by any data structure. Since information does not depend on a data structure, “AAA table” can be described as “AAA information”.

In the following description, “CPU” is a central processing unit including one or more processors. A processor may include a hardware circuit performing a part or all of a process.

In the following description, there is a case that a process is described using “program” as the main of operation. However, since a program is executed by a CPU to perform a predetermined process while properly using a storage resource (for example, memory) or the like, the main of the actual process is the CPU. Therefore, the process described using the program as the main of the operation may be also described that the processor is the main of the process. A part or all of processes performed by a processor may be performed by hardware circuits such as an application specific integrated circuit (ASIC) or a field-programmable gate array (FPGA).

A computer program may be installed from a program source to a device. A program source may be, for example, a program distribution server or a storage medium which can be read by a computer.

### Outline

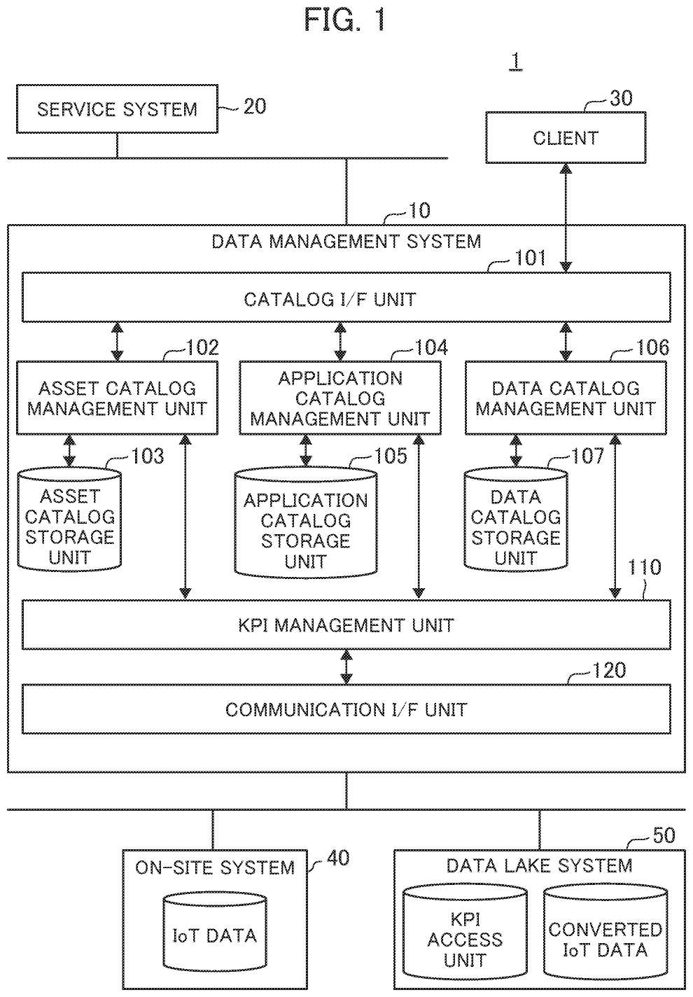

The outline of a system of the embodiment will be described with reference to FIG. 1. The system of the embodiment has an on-site system 40 generating on-site IoT data, a data lake system 50 storing converted IoT data obtained by converting the on-site IoT data to a context of an analysis application, a data management system 10 obtaining the on-site IoT data and the converted IoT data and automatically generating a key performance indicator (KPI) related to production, a service system 20 analyzing the on-site IoT data by the KPI generated by the data management system, and a client terminal 30 providing an analysis result of analysis of the on-site IoT data by the service system to the user.

The data management system 10 has an asset catalog management unit 102 managing an asset catalog in which information of a manufacture line and devices constructing a manufacture line is written, an application catalog management unit 104 managing an application catalog in which calculation information of a KPI is written, a data catalog management unit 106 managing a data catalog in which the locations of on-site IoT data and converted IoT data are written, and a KPI management unit 110.

The KPI management unit 110 obtains an asset catalog, retrieves a KPI as a measurement reference and, when the obtained asset catalog does not include a KPI, repeats the retrieval of a KPI with reference to an application catalog, thereby automatically generating a desired KPI.

### <Description of Terms>

On-site IoT data: On-site data generated by the on-site system. For example, time information such as a timestamp, a counter value indicating the number of processes, and the like generated by a device as a component of a manufacture line.
Converted IoT data: IoT data obtained by converting on-site IoT data to a context of an analysis application.
IoT data: On-site IoT data and converted IoT data.
Asset catalog: Information of a manufacture line and devices constructing a manufacture line. For example, in the case of setting devices constructing a manufacture line as assets, names of the devices, information of parts constructing the devices, and identifiers (IDs) of data catalogs indicating storage locations of operation data and the like of the devices are included.
Application catalog: Data in which calculation information of a KPI as a requirement specification of the service system is written. For example, it is data which describes, to obtain a throughput of a manufacture line, that it is sufficient to calculate devices constructing the manufacture line and the throughput of the devices.
Requirement specification of service system: Specification of a KPI which becomes necessary when the user performs analysis. For example, in the case of obtaining a throughput of a manufacture line, it corresponds to a combination of a line as an asset and a throughput as a KPI. Also in designation of a plurality of devices like “lines”, a line itself may be designated like a “line” asset.
Throughput: Amount of process which can be performed in unit time. For example, it expresses the number of processes which can be performed in unit time by an on-site device such as a work robot. A PLC measures the amount of process performed by an on-site device and transmits it to the data management system.
Context: Information describing IoT data such as unit and acquisition date and time. For example, it is a counter value indicating the number of processes performed by an on-site device and Japan standard time (JST).
Data catalog: Information indicating the storage location of IoT data. For example, as storage locations, an IP address as information necessary for the data management system to access IoT data, a database name, and a table of a database are included.
KPI: A key performance indicator of a manufacturing site. In the embodiment, it is an analysis result desired by the user, for example, a throughput of a manufacture line made by a plurality of PLCs. In the embodiment, a problem that KPIs to be obtained are different among layers of a process manager and a line manager, and manhour to provide desired KPIs to the managers in the layers is required, is solved.
KPI management unit: It performs a recursion execution process of various catalog association. It performs a process of obtaining a KPI required by an analysis application of a service system by making information of various catalogs associated.
Desired KPI: A KPI required by an analysis application of a service system.

### Embodiment

### System Configuration

First, a system according to an embodiment of the present invention will be described.

FIG. 1 is a diagram illustrating an example of a system configuration diagram of the embodiment.

A system 1 has: the on-site system 40 generating data such as various sensor data as on-site IoT data; the data lake system 50 storing data (converted IoT data) obtained by converting the on-site IoT data to a context of an analysis application; the data management system 10 obtaining IoT data made by the on-site IoT data and the converted IoT data and automatically generating a KPI; the service system 20 analyzing the on-site IoT data by the KPI generated by the data management system; and the client terminal 30 providing a result of analysis of the on-site IoT data by the service system 20 to the user. In the specification, the on-site IoT data and the converted IoT data will be called IoT data as an inclusive term.

In FIG. 1, the data lake system 50, the data management system 10, the service system 20, and the client terminal 30 are illustrated as different hardware. However, a part or all of the systems and the terminal may be provided for a single computer or may be configured by using cloud computing.

The data management system 10 has: a communication I/F 120 which is connected to the on-site system 40, the data lake system 50, the service system 20, and the like and enables exchange of communications and control of data; a catalog I/F unit 101 connected to the various catalog management units 102, 104, and 106 and the client terminal 30; a control unit made by the various catalog management units which are the asset catalog management unit 102, the application catalog management unit 104, and the data catalog management unit 106 and the KPI management unit 110; and storage units 103, 105, and 107 storing various catalogs.

The storage units include the asset catalog storage unit 103 in which information of a manufacture line and devices constructing a manufacture line is written, the application catalog storage unit 105 storing an application catalog in which calculation information of a KPI as a requirement specification of the service system is written, and the data catalog storage unit 107 in which a storage location as information necessary for the data management system to access IoT data is written.

The control unit of the data management system 10 has: the catalog management units made by the asset catalog management unit 102 performing registration, deletion, and retrieval of an asset catalog for the asset catalog storage unit 103, the application catalog management unit 104 performing registration, deletion, and retrieval of an application catalog for the application catalog storage unit 105, and the data catalog management unit 106 performing registration, deletion, and retrieval of a data catalog for the data catalog storage unit 107; and the KPI management unit 110 executing a recursive process for obtaining a KPI requested by the analysis application of the service system 20 by making the information of the catalogs of the various catalog management units associated.

To explain the functions of the data management system 10 in FIG. 1 so as to be easily understood, the catalog management units 102, 104, and 106, the KPI management unit 110, the asset catalog storage unit 103, the application catalog storage unit 105, and the data catalog storage unit 107 are illustrated in different function blocks. However, it is not required that those units are different as hardware. The operations of the management units may be performed as a single control unit, and the storage units may be realized by a single storage device such as a hard disk drive.

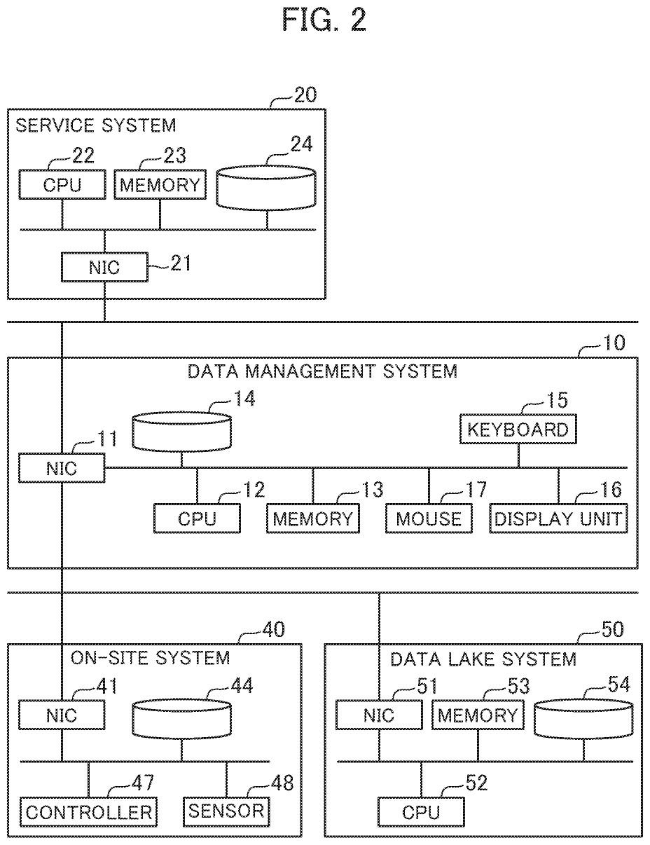

FIG. 2 is a diagram illustrating an example of a hardware configuration diagram of the system of the embodiment. FIG. 2 illustrates the hardware configuration of the on-site system 40, the data lake system 50, the data management system 10, and the service system 20.

The service system 20, the data management system 10, and the data lake system 50 are constructed by, like the configuration of a common PC or server, NICs 21, 11, 51 as communication I/Fs (interfaces), CPUs 22, 12, 52 constructing a control unit, storage devices 24, 14, and 54, and buses connecting those elements, respectively. The on-site system 40 has an NIC 41 as a communication I/F (interface), a storage device 44, various sensors 48, and a controller 47.

The NIC is hardware performing protocol control at the time of communication with another system. For example, in the case of transmitting/receiving data to/from another system via wireless communication, the NIC is constructed by a transmission unit mutually converting a digital signal and a wireless signal, converting generated digital data to a wireless signal, and transmitting the wireless signal, and a reception unit extracting the digital data from the received wireless signal. The NIC is not limited to the wireless communication but may be wired communication.

The service system 20, the data management system 10, the data lake system 50, and the on-site system 40 are connected to one another via a network so as to be able to mutually exchange information. When a part or all of the systems and the terminal are provided for a single computer, they do not have to be connected via a network.

In the data management system 10, the storage device 14 corresponds to the asset catalog storage unit 103, the application catalog storage unit 105, and the data catalog storage unit 107 illustrated in FIG. 1, and is constructed by various drives such as an NVMe drive 119a, an SAS drive 119b, an SATA drive 119c, and the like storing various catalog data, and storing a computer program realizing various processes, obtained on-site IoT data, and the like.

The memory 13 is constructed by a volatile memory such as an SRAM and a DRAM. When the CPU 12 executes a program stored in the memory 13, various functions are realized as the control unit. The memory 13 has a cache region as a cache memory temporarily storing data. The operation unit is constructed by, for example, a keyboard 15, a mouse 17, and the like and used by the user to input various operations and instructions. The display unit 16 is constructed by, for example, a liquid crystal display monitor or the like and displays a necessary screen and process results of various processes.

The sensors 48 in the on-site system 40 are various according to kinds of on-site IoT data to be obtained and are a temperature sensor, an acoustic sensor, and the like. The controller 47 measures a timestamp indicating time information of the on-site system, a counter value indicating the number of processes, and the like. The on-site system 40 provides the information of the sensor 48 and the controller 47 as on-site IoT data to the data management system 10.

### Various Catalogs

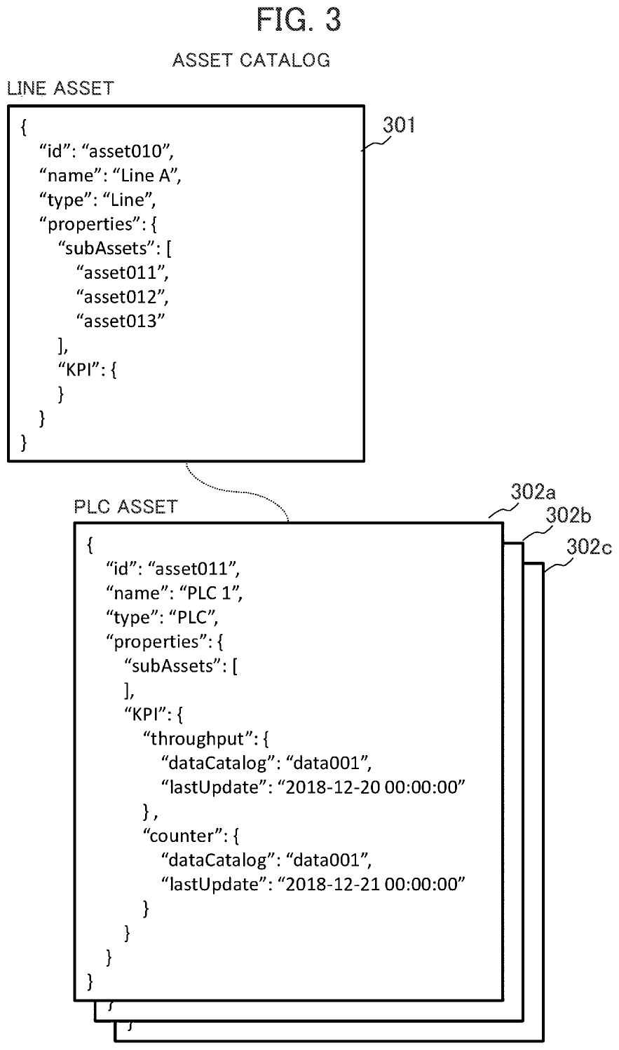

FIG. 3 is a diagram illustrating an example of an asset catalog of the embodiment and illustrates an asset catalog of a manufacture line A to be analyzed. In the asset catalog, a line asset 301 is information related to a manufacture line. In the case of setting devices constructing the manufacture line in the asset catalog as assets, as assets of the devices, the names of the devices and information of the parts constructing the devices, and information indicating the storage locations of operation data of the devices and the like are included. As the information indicating the storage location, the ID (pointer) to a data catalog is written in the asset catalog. The data catalog includes the IP address as information necessary for the data management system to access IoT data, a database name, a table of the database, and the like.

In the line asset 301, “asset010” as the ID for identifying an asset, “Line A” as “name” indicating the name of the asset, “Line” as “type” indicating the type of the asset and, in addition, information of the devices “asset011”, “asset012”, and “asset013” and the like constructing the manufacture line A as subAssets are stored.

A PLC asset 302 is an asset catalog related to a PLC registered as the sub asset of the line asset 301. The PLC asset 302 is information of each of PLCs constructing the line. FIG. 3 illustrates that three PLCs exist in the line asset 301. A PLC asset 302a illustrates information of asset id “asset011” specified by the sub-asset in the line asset 301, and “PLC1” as “name” of the asset name, “PLC” as the type, and “throughput” and “counter” as KPIs are stored. The KPIs of the PLC asset 302 are sub KPIs of the line asset 301. It is illustrated that in the information of “throughput”, pointer data to a data catalog “data001” is stored in “dataCatalog” as data indicating the storage location of the throughput information of the PLC. Time of last updating is written as “lastUpdate”.

Further, “counter” indicating the counter value is similar. In the embodiment, the throughput is an amount of process which can be performed per unit time. For example, it expresses the number of processes which can be performed by an on-site device (industrial robot) per unit time, and the counter value indicates, for example, the number of processes performed by the on-site device. The PLC measures the throughput of the on-site device and transmits it to the data management system 10.

PLC assets 302b and 302c are PLC assets corresponding to the sub assets “asset012” and “asset013” in the line asset 301.

In the case where a line asset and a PLC asset as objects to be analyzed do not exist in an asset catalog, they can be generated by the asset catalog management unit 102. A line asset, a PLC asset, and the like which become unnecessary can be deleted by the asset catalog management unit 102.

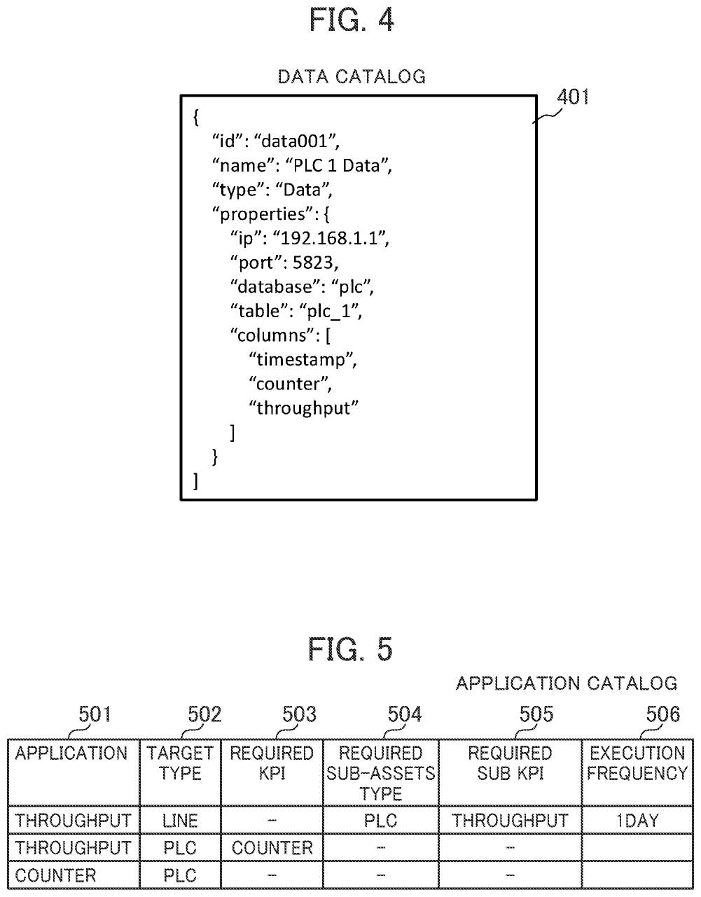

FIG. 4 is a diagram illustrating an example of a data catalog of the embodiment. The data catalog is information indicating the storage location of IoT data. For example, as storage locations, an IP address, a database name, a table of a database, and the like are included. On precondition that IoT data has a timestamp, the IoT data itself is stored in the storage device 54 of the data lake system 50 and the storage device 44 of the on-site system 40, and the information indicating the storage location is managed as a data catalog.

In the example illustrated in FIG. 4, in a data catalog 401, “data001” as the identifier “id” specifying the data catalog, the data catalog name “PLC 1 Data” as “name”, “Data” as “type”, the ip address “192.168.1.1” as the storage location of data, port “5823”, and the like are stored. The id “data001” of the data catalog is the id stored as information indicating the throughput of the KPI of the PLC asset 302a illustrated in FIG. 3.

In the case where a data catalog as an object to be analyzed does not exist, it can be generated by the data catalog management unit 106. A data catalog which becomes unnecessary can be deleted by the data catalog management unit 106.

FIG. 5 is a diagram illustrating an example of an application catalog of the embodiment. The application catalog is data in which calculation information of a KPI as a requirement specification of the service system 20 is written. For example, as a KPI, when it is desired to obtain the throughput of a manufacture line, the application catalog is data describing that it is sufficient to calculate a device as a component of the line and the throughput of the device as a sub KPI.

In the application catalog, for example, a throughput and a counter value as KPIs the user desires to obtain as an analysis result are stored as an application 501, and a line and a PLC are stored as objects to be analyzed as a target type 502. In the case where there is another KPI (sub KPI) necessary to obtain the application 501 (the KPI the user desires to obtain as an analysis result) as a required KPI 503, the another KPI is stored. For example, in the case where the throughput of the PLC is the KPI the user desires to obtain as an analysis result, the counter value “counter” of the PLC or the like is stored.

Like the required KPI 503, a required sub-assets type 504 is also stored when there is a sub-asset type necessary to obtain the application 501. For example, when the throughput of the line is a KPI, a PLC as a component of the line or the like is stored. In the case where there is information such as a required sub KPI 505, execution frequency 506, and the like, the information is stored. For example, when the throughput of the line is set as the KPI, in the case where a PLC as a component of the line is registered as a required sub-assets type 504, the required sub KPI 505 and the execution frequency 506 related to the PLC are stored as “throughput” and “1 day”.

In the service system 20, in the case where the user wants to know the throughput of the line, “Line” of the target type 502 and “throughput” of the application 501 are specified. When the target type 502 and the application 501 are specified, the required sub-assets type 504, the required sub KPI 505, and the execution frequency 506 are grasped as “PLC”, “throughput”, and “1 day”, respectively. That is, as data (calculation information) necessary for calculating a KPI as a requirement specification of the service system, the required KPI 503, the required sub-assets type 504, the required sub KPI 505, the execution frequency 506, and the like are grasped.

When the application 501, the target type 502, the required KPI 503, the required sub-assets type 504, the required sub KPI 505, the execution frequency 506, and the like do not exit in the application catalog, they can be generated by the application catalog management unit 104. The application catalog which becomes unnecessary can be deleted by the application catalog management unit 104.

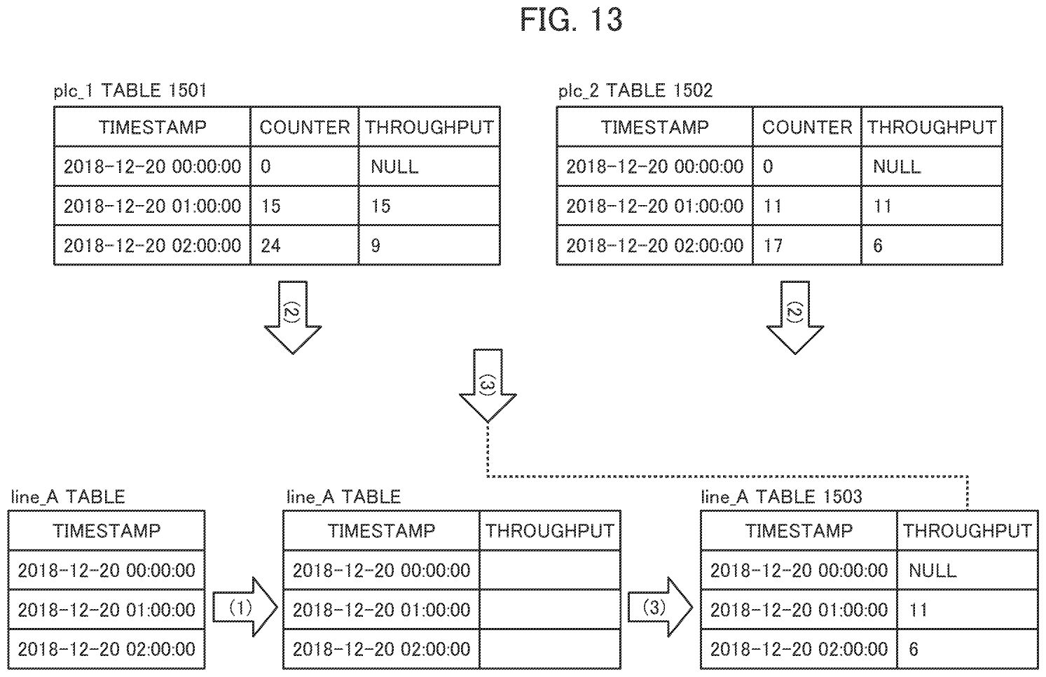

An example of operation that the data management system 10 provides a desired KPI to the service system 20 will be described. In the operation of providing a desired KPI, different processes are executed in rows (for example, a combination of throughput and line) described in FIG. 5. In the embodiment, a case that the user desires to know the throughput of line A constructed by a plurality of devices as a KPI will be described as an example.
(1) The service system, the user, or the KPI management unit 110 (in the case of recursion execution) in the data management system inquires the data management system 10 for the throughput of the line A (id: asset010).
(2) The KPI management unit 110 determines whether the throughput exists as a KPI or not with reference to the asset catalog of asset010. Since it does not exist in the example illustrated in FIG. 3, an application catalog is retrieved and the calculation information of the throughput of the line is specified. At this time point, it is understood that the throughput of the PLC as a component of the line asset is necessary for calculation of the throughput of the line asset.
(3) The KPI management unit 110 obtains a PLC list included in Line A with reference to the asset catalog of the line asset.
(4) The KPI management unit 110 determines whether throughput is calculated or not with reference to the asset catalog of the PLC asset.
(5) The KPI management unit 110 determines that the required sub KPI is the throughput value of the PLC as a component of Line A, and reads the throughput value of the PLC as a component of the line from the data lake.
(6) The throughput of the line is obtained from the throughput of the PLC as a component of the line. An example of this process will be described with reference to FIG. 13.

### Various Input Screens

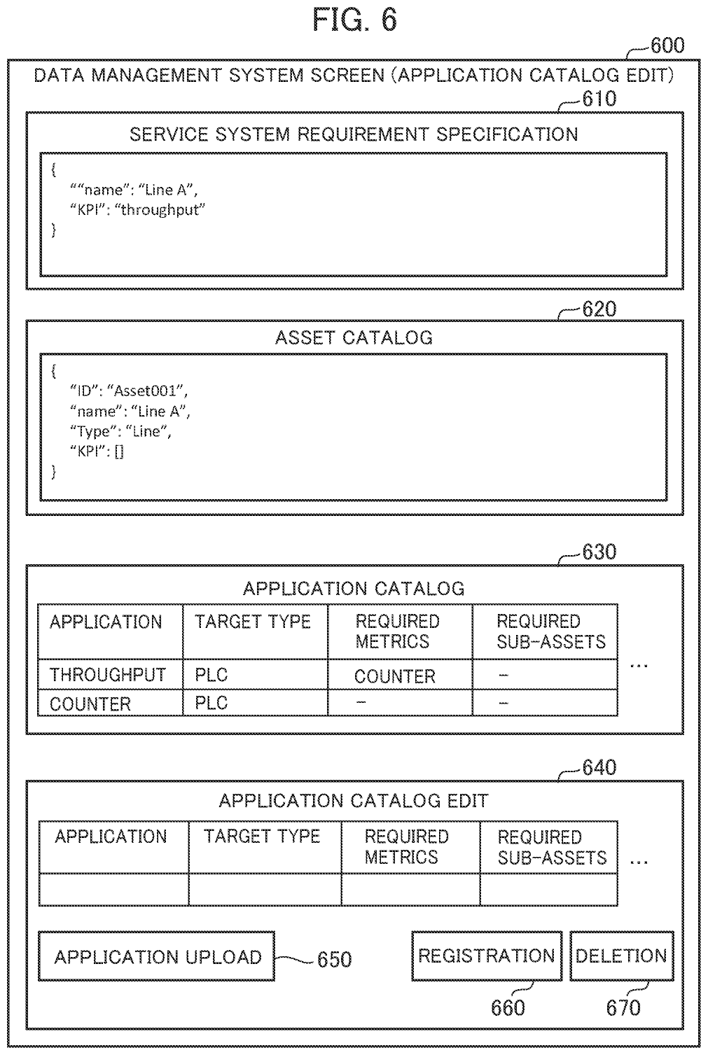

FIG. 6 is a diagram illustrating an example of a display screen of the data management system of the embodiment. The screen is used for editing an application catalog by the control of the KPI management unit 110.

In a display screen 600 of the data management system, display regions of a service system requirement specification region 610, an asset catalog region 620, an application catalog region 630, and an application catalog edit region 640 and, in addition, an application upload button 650, a registration button 660, and a deletion button 670 are displayed.

The service system requirement specification region 610 is a region of displaying a specification of a service required by the user using the service system 20 by the KPI management unit 110. In this case, it illustrates that an object to be analyzed is “Line A”, and the KPI desired to be obtained is “throughput”.

The asset catalog region 620 displays, for example, an asset id or the like as an object to be analyzed as the target of a service. In this case, asset id “Asset001”, asset name “Line A”, asset type “Line” and the like are displayed. The KPI management unit 110 in the above-described (2) refers to the asset catalog of the asset010, determines whether throughput exists as a KPI or not and, when the application catalog is searched and no application can be found, performs display of FIG. 6 to urge the user to register an application.

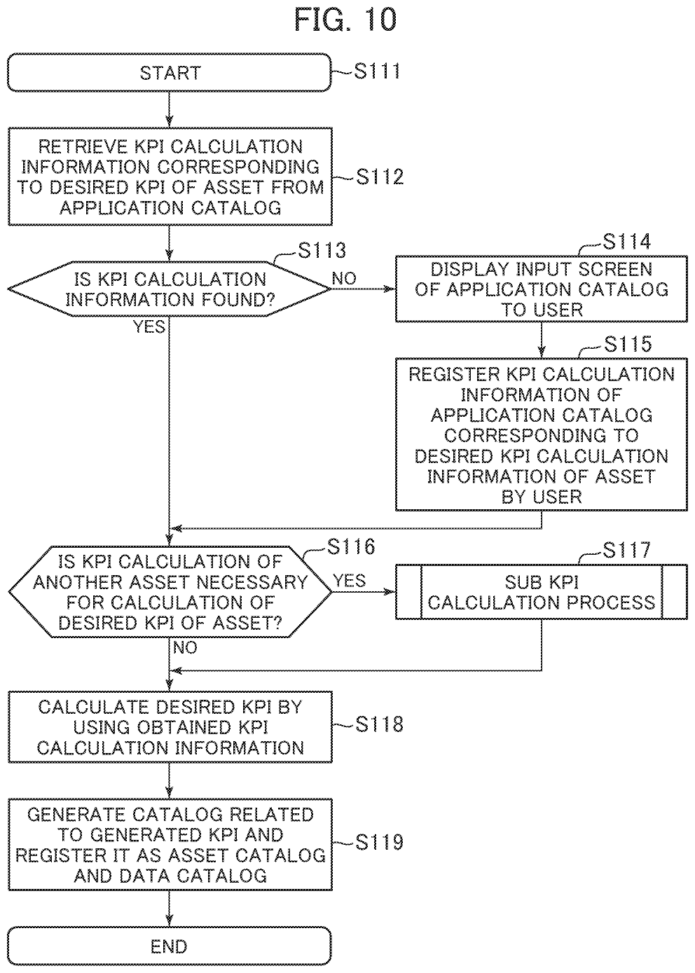

In the application catalog region 630, an application catalog is displayed by the KPI management unit 110, and the application catalog is edited by using the application catalog edit region 640. The usage of FIG. 6 will be described also with reference to FIG. 10.

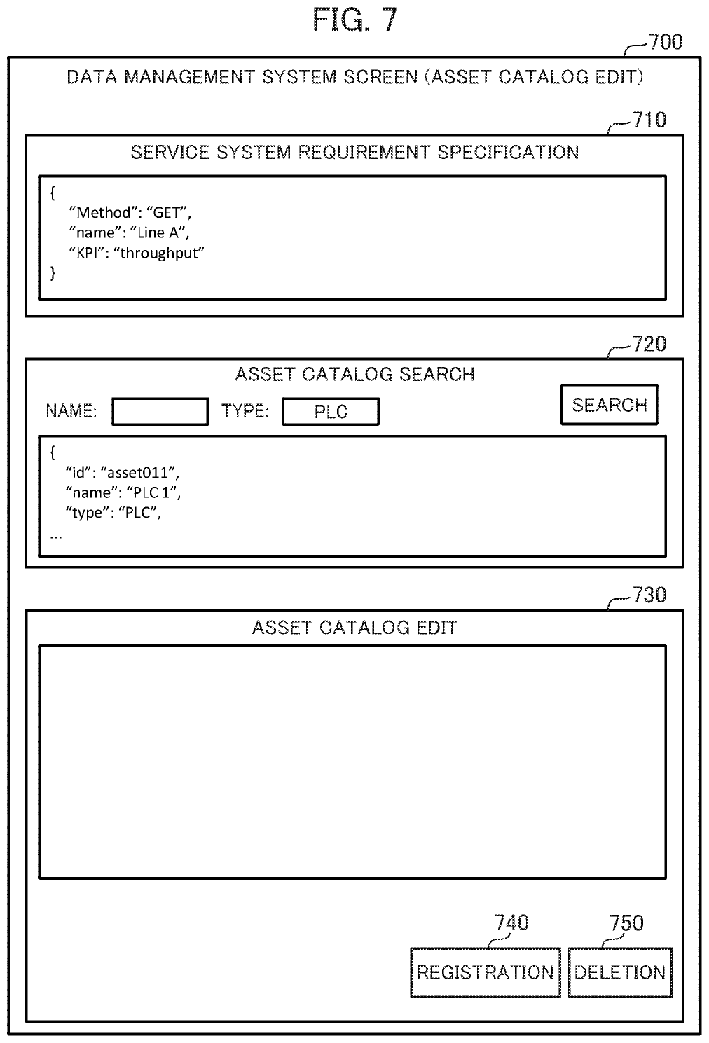

FIG. 7 is a diagram illustrating an example of the display screen of the data management system of the embodiment and corresponds to service system requirement specifications (specification of an object to be analyzed and KPI desired to be obtained). It is a screen for performing asset catalog retrieval and asset catalog edit by the control of the KPI management unit 110.

Like FIG. 6, in a service system requirement specification display region 710, specifications of service required by the user using the service system 20 are displayed by the KPI management unit 110.

In an asset catalog search 720, name, type, and the like of an asset as an object to be retrieved are designated, and an asset stored in the asset catalog storage unit 103 is retrieved. FIG. 7 illustrates a state that “PLC” is designated as type, and an asset of asset id “asset011”, name “PLC 1”, and type “PLC” is retrieved.

In an asset catalog edit 730, the content of the asset catalog is edited, and an asset as an object to be edited is registered by a registration button 740 and deleted by a deletion button 750.

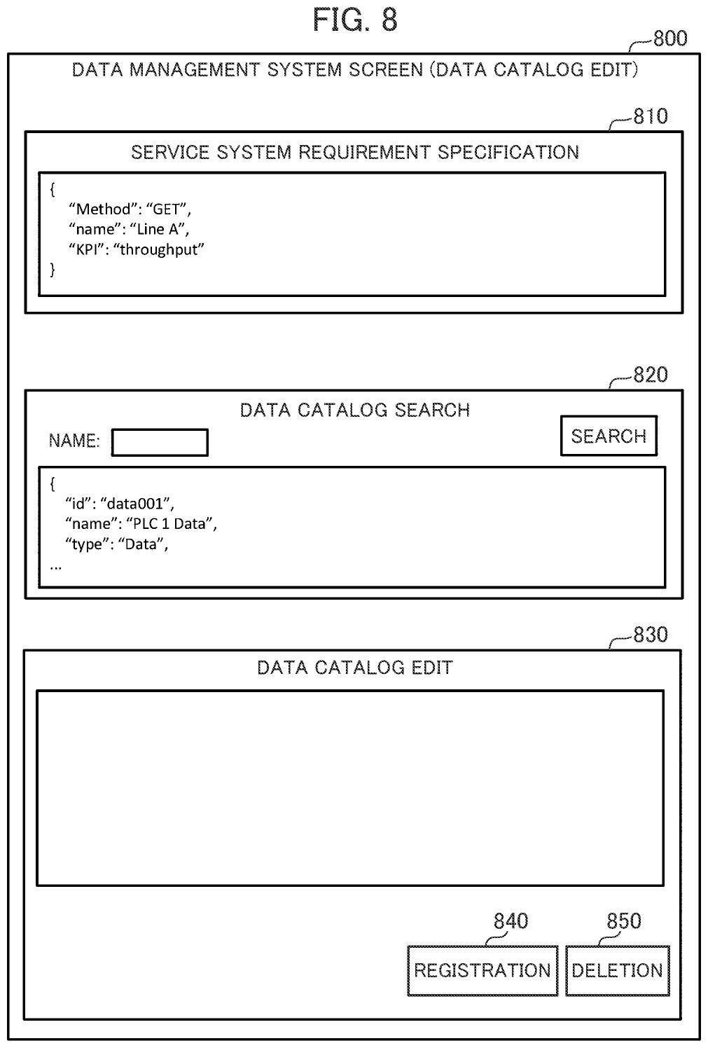

FIG. 8 is a diagram illustrating an example of the display screen of the data management system of the embodiment. It is a screen for performing data catalog retrieval and data catalog edit for service system requirement specification (specification of an object to be analyzed and a KPI desired to be obtained) by the control of the KPI management unit 110.

Like FIGS. 6 and 7, in a service system requirement specification display region 810, the specification of a service required by the user using the service system 20 is displayed by the KPI management unit 110.

In a data catalog search 820, “id” as identifier, “name”, “type”, and the like of data as an object to be retrieved are designated, and an asset stored in the data catalog storage unit 107 is retrieved. FIG. 8 illustrates a state where an asset of id “data001”, name “PLC 1 Data”, and type “Data” is retrieved.

In data catalog edit 830, the content of a data catalog is edited, and an asset as an object to be edited is registered by a registration button 840 and deleted by a deletion button 850.

### Processing Operation of Data Management System

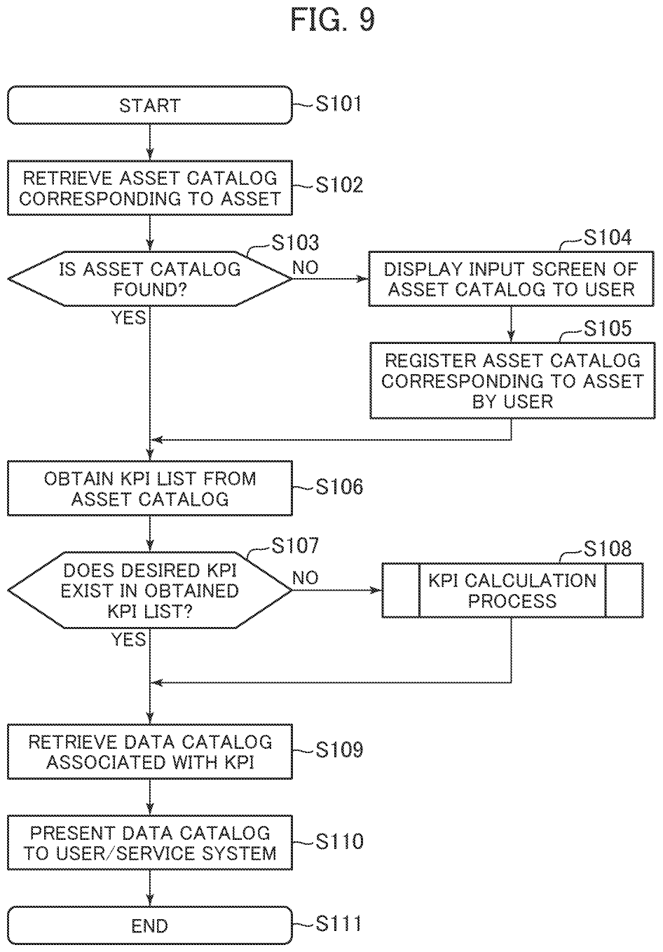

FIG. 9 is a diagram illustrating an example of a process flow of the data management system of the embodiment.

The process operation of the data management system 10 in the case where the user desires to obtain a KPI with respect to a predetermined asset by the service system 20 will be described. To make the content of the invention easily understood, the process operation of the data management system 10 in the case where the user sets the throughput of Line A which is an object to be analyzed, as a KPI desired to be obtained by the service system 20 will be described. Obviously, an object to be analyzed and a KPI are not limited to Line A and throughput. Various combinations are included and, particularly, the combinations in the rows in FIG. 5 can be considered.

In step S101, Line A as an asset and throughput as a KPI are input by the user from the operation unit of the data management system 10 to the control unit (concretely, the asset catalog management unit 102).

In step S102, the asset catalog management unit 102 retrieves an asset catalog corresponding to the asset. That is, the asset catalog of Line A is retrieved.

In step S103, the asset catalog management unit 102 determines whether the asset catalog of Line A could be found or not, when it could be found, advances to step S106 and, when it could not be found, advances to step S104.

In step S104, the asset catalog management unit 102 displays the input screen (FIG. 7) of the asset catalog of Line A on the display unit 16 to the user. The asset catalog of the asset which is input in step S101 is generated.

Subsequently, in step S105, the asset catalog management unit 102 registers an asset catalog corresponding to the asset by the user from the asset catalog edit screen illustrated in FIG. 7. That is, the asset catalog 301 of Line A illustrated in FIG. 3 is registered.

In step S106, the asset catalog management unit 102 obtains a KPI list from the asset catalog. That is, a KPI included in the asset catalog of Line A is obtained. When the asset catalog of Line A could be found in step S103, the KPI list included in the asset catalog is obtained. In step S105, when the user inputs the KPI of the line asset, the information is obtained.

In step S107, the control unit (concretely, the KPI management unit 110) of the data management system 10 determines whether a desired KPI exists in the obtained KPI list or not. That is, the KPI management unit 110 determines whether or not the throughput as the desired KPI as the requirement specification of the service system exists in the obtained KPI list. In the case where it exists, the unit advances to step S109. In the case where it does not exist, the unit advances to step S108. The KPI calculating process of step S108 will be described later with reference to FIG. 10.

In step S109, the asset catalog management unit 102 retrieves a data catalog associated with the KPI. That is, when a data catalog expressing the throughput exists in the asset catalog of Line A, the data catalog is retrieved. FIG. 3 expresses an example that a data catalog associated with the throughput does not exist in the asset catalog 301 of Line A and a data catalog is associated with a KPI (throughput) in an asset catalog (PLC asset 302) of the PLC as the component of Line A. In the case where a data catalog is associated with the KPI of the line asset 301 like the KPI of the PLC asset of FIG. 3, the data catalog is retrieved.

In step S110, the asset catalog management unit 102 reads IoT data from the storage location in the data lake system 50 or the on-site system 40 indicated in the data catalog, and presents it as a desired KPI to the user/service system.

FIG. 10 is a diagram illustrating an example of the process flow of the data management system of the embodiment, and illustrates the details of the process content of step S108 in FIG. 9.

In step S108 in FIG. 9, in the case where a desired KPI does not exist in the obtained KPI list, that is, in the case where a throughput as a desired KPI does not exist in the asset catalog of Line A, the control unit (concretely, the KPI management unit 110) of the data management system 10 starts a process (step S111).

In step S112, the KPI management unit 110 retrieves KPI calculation information corresponding to a desired KPI of the asset from the application catalog. Concretely, since the user sets a throughput as the desired KPI with respect to Line A, referring to the application catalog illustrated in FIG. 5, the required KPI 503, the required sub-assets type 504, the required sub KPI 505, and the like are retrieved. As a result, the required sub-assets type 504 “PLC”, the required sub KPI 505 “throughput”, and the execution frequency 506 “1 day” are found as KPI calculation information.

In step S113, the KPI management unit 110 determines whether KPI calculation information could be found or not. In the case where KPI calculation information could be found, the unit advances to step S116. In the case where KPI calculation information could not be found, the unit advances to step S114.

In step S114, the KPI management unit 110 displays an input screen of the application catalog as illustrated in FIG. 6 on the display unit 16 to the user. Concretely, the user checks the service system requirement specification 610 and specifies an application to be registered in the application catalog. In the embodiment, throughput calculation for a line asset is specified. The user refers to the asset catalog 620, refers to an asset (line asset) corresponding to an asset to be analyzed and an asset (PLC or the like) related to the asset, and checks whether a KPI necessary to calculate the throughput is calculated or not. While referring to the application catalog region 630, the user enters an application and a target type corresponding to the service system requirement specification by operating the keyboard or mouse in the application catalog edit region 640. That is, catalog information of an application defined by “throughput” as application and “Line” as target type is entered. By clicking an application upload button, KPI calculation information corresponding to the catalog information is registered in the application catalog. An unnecessary application may be deleted by clicking the deletion button.

In step S115, the KPI management unit 110 registers the KPI calculation information of the application catalog corresponding to desired KPI calculation information of the asset by the user. In the embodiment, “PLC” as a component of Line A is registered in the required sub-assets type 504, and the throughput of the PLC or the like is registered in the required sub KPI 505.

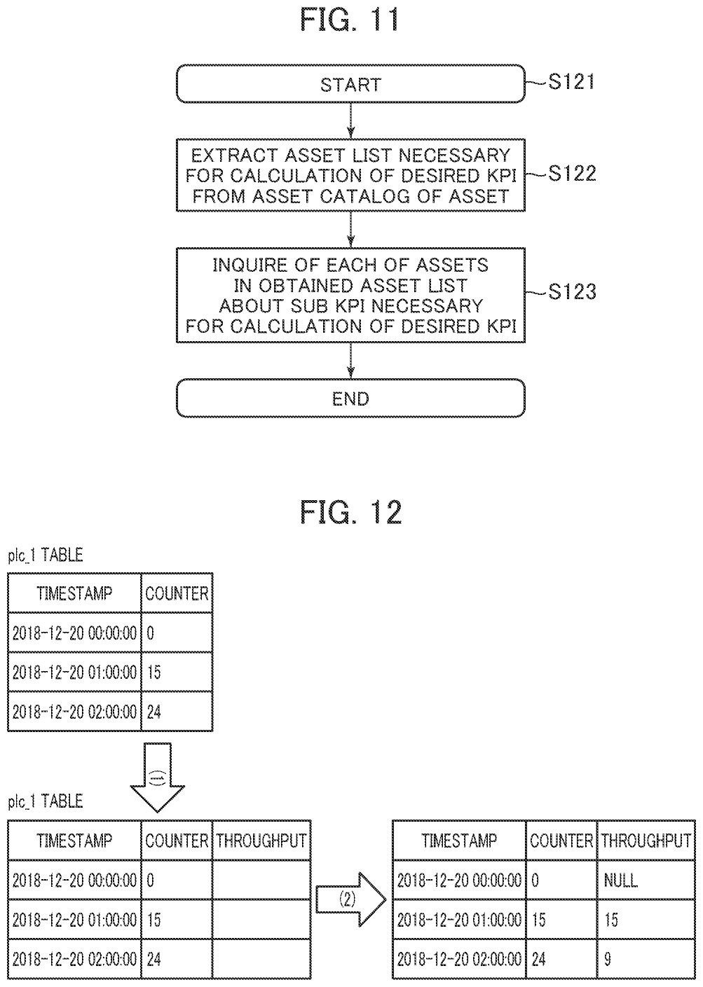

In step S116, the KPI management unit 110 determines whether calculation of the KPI of another asset is necessary for calculation of a desired KPI of the asset or not. Specifically, it determines whether or not the KPI (sub KPI) of the asset such as the PLC or the like as a component of Line A is necessary to calculate the throughput of Line A as a desired KPI. When it is determined in step S116 that calculation of the KPI of another asset is necessary, the unit advances to step S117. When it is determined that the calculation is unnecessary, the unit advances to step S118. The process in step S117 will be described with reference to FIG. 11.

In step S118, the KPI management unit 110 calculates a desired KPI by using the obtained KPI calculation information. Specifically, the KPI management unit 110 calculates the throughput of Line A as a desired KPI by the required sub-assets type 504 “PLC”, the required sub KPI 505 “throughput”, and the execution frequency 506 “1 day” registered in the application catalog.

In step S119, the KPI management unit 110 generates a catalog related to the generated KPI and registers it as an asset catalog and a data catalog. Specifically, the throughput of Line A is registered in the asset catalog of Line A, and the value of the throughput generated together with the storage destination of data is registered in the data catalog. Referring to the asset catalog of FIG. 3, “throughput” and information of the data catalog are registered in the KPI of the line asset 301, and a state like the PLC asset in which those information is registered is obtained.

FIG. 11 is a diagram illustrating an example of the process flow of the data management system of the embodiment, and illustrates the details of the process of step S117 in FIG. 10. When it is determined in step S116 in FIG. 10 that calculation of the KPI of another asset is necessary for calculation of a desired KPI of the asset, the process of FIG. 11 is started (S121).

In step S122, the KPI management unit 110 extracts an asset list necessary to calculate a desired KPI from the asset catalog of the asset. In the case of the asset catalog illustrated in FIG. 3, as the asset list necessary to calculate the throughput from the asset catalog of Line A, three sub assets “asset011”, “asset012”, and “asset013” corresponding to PLCs constructing Line A are extracted.

In step S123, each of the assets in the obtained asset list is inquired for a sub KPI necessary to calculate a desired KPI. Specifically, each of the obtained three sub assets is inquired for a sub KPI necessary to calculate the throughput of Line A. For the PLCs constructing Line A, the throughput of each of the PLCs is inquired. The throughput of each of the PLCs inquired in this step is the KPI calculation information obtained in step S118 in FIG. 10.

### KPI Calculation Process

FIG. 12 is a diagram explaining a method of calculating the throughput of a PLC which is necessary to calculate a desired KPI (throughput of Line A) from a data catalog associated with the KPI of the PLC asset.

In the example of FIG. 12, in the case where only a timestamp and a counter value exist as a KPI and a throughput does not exist in a PLC asset, (1) first, a table for registering a throughput is generated in the PLC asset. (2) Next, the KPI management unit 110 calculates the throughput at the time of registration of each timestamp from the timestamp and the counter value and registers it in a corresponding throughput column.

Since the counter value at the time of the timestamp “2018-12-20 00:00:00” is “0” and the counter value at the time of the timestamp “2018-12-20 01:00:00” is “15”, throughput “15” at the time of the timestamp “2018-12-20 01:00:00” is registered. Since the counter value at the time of the timestamp “2018-12-20 02:00:00” is “24” and the counter value at the time of the timestamp “2018-12-20 01:00:00” is “15”, “9” as the difference between the throughputs “24” and “15” is registered at the time of the timestamp “2018-12-20 02:00:00”.

FIG. 13 is a diagram explaining a method of calculating a KPI of a line from KPIs of devices constructing the line. In the embodiment, in the case where Line A is constructed by two PLCs, a method of calculating the throughput of Line A from the throughputs of the PLCs will be described.

In the case where throughputs are registered as KPIs of PLCs or in the case of calculating a throughput, a method of calculating the throughput of Line A by using the throughputs of the PLCs will be described.
(1) First, a column for registering a desired KPI in a line asset is generated.
(2) Next, a PLC1 table 1501 and a PLC2 table 1502 storing throughputs at the time of timestamps of PLC1 and PLC2 from the data catalog associated with the PLC asset are read from the data lake.
(3) Subsequently, the throughputs of PLC1 and PLC2 are compared and the value of the smaller one of the throughputs is set as the throughput of Line A. PLC1 and PLC2 have the information of the same timestamp. For example, since the throughput of PLC1 is “15” and the throughput of PLC2 is “11” at the time of the timestamp “2018-12-20 01:00:00”, the throughput of Line A is calculated as “11”. Similarly, since the throughput of PLC1 is “9” and the throughput of PLC2 is “6” at the time of timestamp “2018-12-20 02:00:00”, the throughput of Line A is calculated as “6”. The throughput of the entire line is determined by the value of smaller one of the throughputs of the two PLCs constructing the line.

As described above, even in the case where the throughput of Line A is not included as a desired KPI in the line asset, by referring to or calculating the throughputs of the PLCs constructing the line, the throughput of Line A can be obtained.

According to the embodiment as described above, the users in the layers of a factory, manufacture lines constructing the factory, devices constructing the manufacture lines, and the like can obtain a desired KPI in each layer without having the knowledge of the other layers.

The manager of a factory or a manufacture line can grasp a KPI such as the throughput of the factory or the manufacture line without specialized knowledge on the storage location of IoT data of devices constructing the manufacture line and context of IoT data.

Without having specialized knowledge regarding an object to be analyzed (for example, a manufacture line or PLCs constructing a manufacture line), reuse of an analysis application having different contexts such as data units or data acquisition times of on-site data (for example, data of PLCs) can be realized in short manhour.

What is claimed is:

1. A data management system providing IoT data to a service system, comprising:
a storage device storing an asset catalog in which information of a manufacture line and devices constructing a manufacture line is written as an asset, an application catalog in which calculation information of a KPI as a required specification of the service system is written, and a data catalog in which information for accessing the IoT data is written; and
a control unit retrieving an asset to be analyzed from the asset catalog, when the KPI does not exist in the searched asset catalog, retrieving KPI calculation information from the application catalog, and calculating a KPI of the asset to be analyzed as the KPI as the required specification of the service system by using the retrieved KPI calculation information.

2. The data management system according to claim 1,
wherein when calculation of sub KPIs of other assets constructing the asset to be analyzed is necessary for the KPI calculation information, the control unit extracts a list of the other assets constructing the asset to be analyzed, obtains sub KPIs of the other assets extracted, and performs a recursion process of calculating the KPI of the object to be analyzed by using the obtained sub KPIs.

3. The data management system according to claim 2,
wherein the data management system is connected to an on-site system generating on-site IoT data, a data lake system storing converted IoT data which is obtained by converting the on-site IoT data to a context of an analysis application, and the service system analyzing the on-site IoT data, and obtains IoT data from at least one of the on-site system and the data lake system, and
wherein information accessing IoT data written in the data catalog is information for accessing the on-site IoT data stored in the on-site system and the converted IoT data stored in the data lake system.

4. The data management system according to claim 2,
wherein the asset to be analyzed is a manufacture line constructed by a plurality of devices,
wherein other assets constructing the asset to be analyzed are a plurality of devices constructing the manufacture line,
wherein a KPI of the asset to be analyzed is a throughput of the manufacture line, and
wherein the sub KPI is a throughput of each of the plurality of devices.

5. The data management system according to claim 2, further comprising a display device displaying a service system requirement specification region, an asset catalog region, an application catalog region, and an application catalog edit region,
wherein when the KPI calculation information cannot be retrieved from the application catalog corresponding to the asset to be analyzed, the control unit registers the asset to be analyzed to the application catalog by using the application catalog edit region in the display device.

6. The data management system according to claim 2, further comprising a display device displaying a service system requirement specification region, an asset catalog retrieval region, and an asset catalog edit region,
wherein when the asset to be analyzed cannot be retrieved from the asset catalog, the control unit registers the asset to be analyzed to the asset catalog by using the asset catalog edit region in the display device.

7. A data management method of a data management system providing IoT data to a service system, comprising the steps of:
storing, in a storage device, an asset catalog in which information of a manufacture line and devices constructing a manufacture line is written as an asset, an application catalog in which calculation information of a KPI as a requirement specification of the service system is written, and a data catalog in which information for accessing the IoT data is written; and
retrieving, by a control unit, an asset to be analyzed from the asset catalog, when the KPI does not exist in the searched asset catalog, retrieving KPI calculation information from the application catalog, and calculating a KPI of the asset to be analyzed as the KPI as the requirement specification of the service system by using the retrieved KPI calculation information.

8. The data management method according to claim 7,
wherein when calculation of sub KPIs of other assets constructing the asset to be analyzed is necessary for the KPI calculation information, the control unit extracts a list of other assets constructing the asset to be analyzed, obtains sub KPIs of the extracted other assets, and performs a recursion process of calculating the KPI of the object to be analyzed by using the obtained sub KPIs.

9. The data management method according to claim 8,
wherein the data management system is connected to an on-site system generating on-site IoT data, a data lake system storing converted IoT data which is obtained by converting the on-site IoT data to a context of an analysis application, and the service system analyzing the on-site IoT data, and obtains IoT data from at least one of the on-site system and the data lake system, and
wherein information for accessing IoT data written in the data catalog is information for accessing the on-site IoT data stored in the on-site system and the converted IoT data stored in the data lake system.

10. The data management method according to claim 8,
wherein the asset to be analyzed is a manufacture line constructed by a plurality of devices,
wherein other assets constructing the asset to be analyzed are a plurality of devices constructing the manufacture line,
wherein a KPI of the asset to be analyzed is a throughput of the manufacture line, and
wherein the sub KPI is a throughput of each of the plurality of devices.

11. The data management method according to claim 8,
wherein the data management system displays a service system requirement specification region, an asset catalog region, an application catalog region, and an application catalog edit region on a display device, and
wherein when the KPI calculation information cannot be retrieved from the application catalog corresponding to the asset to be analyzed, the control unit registers the asset to be analyzed in the application catalog by using the application catalog edit region in the display device.

12. The data management method according to claim 8,
wherein the data management system displays a service system requirement specification region, an asset catalog retrieval region, and an asset catalog edit region on a display device, and
wherein when the asset to be analyzed cannot be retrieved from the asset catalog, the control unit registers the asset to be analyzed in the asset catalog by using the asset catalog edit region in the display device.
